(19) United States
(12) Patent Application Publication
(10) Pub. No.: US 2020/0160006 A1
(43) Pub. Date: May 21, 2020

(54) Systems and Methods for Authenticating an Item

(71) Applicants: Peter Godwin, Seattle, WA (US); Aileen Reyes-Picknell, Barrie (CA)

(72) Inventors: Peter Godwin, Seattle, WA (US); Aileen Reyes-Picknell, Barrie (CA)

(21) Appl. No.: 16/690,540

(22) Filed: Nov. 21, 2019

Related U.S. Application Data
(60) Provisional application No. 62/770,699, filed on Nov. 21, 2018.

(51) Int. Cl. G06K 7/10

(52) U.S. Cl. CPC G06K 7/10366; H04L 9/06

(57) ABSTRACT

Systems and methods are provided for ensuring the authenticity of a collectable such as a bottle of wine. The systems and methods include placing identification elements (e.g. tags), such as RFID tags, at various locations on the collectable and storing a relative location of at least one of the tags as compared to at least one other tag. Interrogating the tags with a tag reader and comparing the current information with the stored information. The systems and methods may further include associating at least one code with at least on of the identification elements.

### FIELD OF THE TECHNOLOGY

The technology of this application relates generally to product identification/authentication and more particularly but not exclusively to authenticating an item using identification technology.

### BACKGROUND OF THE TECHNOLOGY

With any collectable product such as wine, where the value of the collectable may rise into the many thousands and even millions of dollars, there is the unfortunate problem of unscrupulous people attempting to profit from counterfeits. In fact, the fake wine market is a multi-billion-dollar industry.

While there are various technologies which attempt to solve the problem of counterfeits, most are unreliable, unduly complicated and expensive to implement and can be circumvented by ingenious criminals.

It may be advantageous to create systems and methods for authenticating a valuable collectable in a reliable manner.

### BRIEF SUMMARY OF THE TECHNOLOGY

Many advantages will be determined and are attained by one or more embodiments of the technology, which in a broad sense provides systems and methods for authenticating a collectable by placing an array of identification elements on the collectable such that the arrangement of the array itself may be part of the identification. One or more of the identification elements may identify their location relative to one or more other identification elements. If an identification element is moved, that may indicate tampering with the authenticity of the collectable.

In one or more embodiments, one or more codes may be associated with one or more of the identification elements. The codes may be interspersed between/among the identification elements, and/or between/among the identification elements and the collectable itself. The codes may be associated with one or more identification elements that provide(s) location information and/or one or more identification elements that do(es) not provide location information but has/have information stored apart from the physical identification element.

One or more embodiments of the invention provide(s) a system for authenticating a collectable. The system may include identification elements connected to the collectable. At least two of the identification elements may have a location relative to one another. The system may also include a storage device associated with the identification elements. The relative location between at least two of the identification elements is stored in the storage device.

One or more embodiments of the invention provide(s) a method for authenticating a collectable. The method may include connecting multiple identification elements to the collectable and determining a relative location of at least one of the identification elements with respect to another of the identification elements. The method may also include associating the relative location with at least one of the identification elements and storing the relative location and the association in a storage.

One or more embodiments of the invention provide(s) a method for authenticating a collectable. The method may include connecting identification elements in an array to the collectable and storing a configuration of the array in a storage that is remote from the collectable. The method may also include interrogating at least one of the identification elements to determine the array configuration comparing the stored configuration to the determined configuration to determine if they match.

The technology will next be described in connection with certain illustrated embodiments and practices. However, it will be clear to those skilled in the art that various modifications, additions and subtractions can be made without departing from the spirit or scope of the claims.

### BRIEF DESCRIPTION OF THE DRAWINGS

For a better understanding of the technology, reference is made to the following description, taken in conjunction with any accompanying drawings in which:

FIG. 1 illustrates a front view of an exemplary collectable which is configured in accordance with one or more embodiments of the disclosed technology;

FIG. 2 illustrates a rear view of the collectable of FIG. 1;

FIG. 3 illustrates the exemplary collectable of FIG. 1 providing the cork inserted into the collectible and covered;

FIG. 4 illustrates a block diagram of a system for authenticating a collectable in accordance with one or more embodiments of the disclosed technology;

FIG. 5 illustrates a block diagram of a system for authenticating a collectable in accordance with one or more embodiments of the disclosed technology illustrating security codes;

FIG. 6 illustrates a block diagram of a system for authenticating a collectable in accordance with one or more embodiments of the disclosed technology illustrating multiple identification elements located on a single label;

FIG. 7 illustrates a front view of an exemplary collectable which is configured with a label and a separate identification element in accordance with one or more embodiments of the disclosed technology; and,

FIG. 8 illustrates a front view of an exemplary collectable which is configured with multiple labels each having at least one identification element associated therewith in accordance with one or more embodiments of the disclosed technology.

The technology will next be described in connection with certain illustrated embodiments and practices. However, it will be clear to those skilled in the art that various modifications, additions, and subtractions can be made without departing from the spirit or scope of the claims.

### DETAILED DESCRIPTION OF THE TECHNOLOGY

One or more embodiments of the technology provides, in a broad sense, systems and methods for authenticating a valuable collectable. An array of identification elements may be attached to or otherwise associated with the bottle to provide an ability to determine if the bottle has been tampered with. The array of identification elements may provide information about the collectable, such as serial number, origin, year created, etc. as well as the location of one or more identification elements relative to one or more other identification elements and/or relative to the collectable. One or more of the identification elements may include one or more codes that relate(s) the identification element to the collectable and/or to another of the identification elements. Additionally, one or more of the identification elements may provide a location of the element and/or other elements or it may only provide identification information. Similar to a puzzle, all of the pieces must fit together in the correct order to authenticate the collectable.

Discussion of an embodiment, one or more embodiments, an aspect, one or more aspects, a feature, one or more features, or a configuration or one or more configurations, an instance or one or more instances is intended be inclusive of both the singular and the plural depending upon which provides the broadest scope without running afoul of the existing art and any such statement is in no way intended to be limiting in nature. Technology described in relation to one or more of these terms is not necessarily limited to use in that embodiment, aspect, feature or configuration and may be employed with other embodiments, aspects, features and/or configurations where appropriate.

For purposes of this disclosure “collectable” may mean any item that would be of interest to a collector of such items. By way of a non-exhaustive list of examples, wine, other alcohol, cars, books, art, etc. For ease of description, the disclosure may refer to a wine bottle as the collectable, but that is solely for ease of explanation and is not intended as limiting the technology to wine bottles.

For purposes of this disclosure “identification element” may mean an active and/or passive radio frequency identification (“RFID”) tag, a smart label with an RFID element or some other conventional location identification technology. It may also or alternatively mean an identification element that does not provide location information, but which provides information that is associated with the identification element that may be stored at a location that is remote from the element. By way of a non-limiting example, an identification element may be a code that is associated with a passive or active element that can be interrogated with a reader. In one or more embodiments, the reader may be required to be proximal the identification element to interrogate the identification element and in one or more embodiments, the reader may be remote from the identification element and be able to interrogate the identification element. The interrogation may provide information about the code such as the actual code and/or the location of the code on a label and/or on the collectable.

For purposes of this disclosure “array” may mean a defined arrangement.

For purposes of this disclosure “connected” may mean directly or indirectly connected.

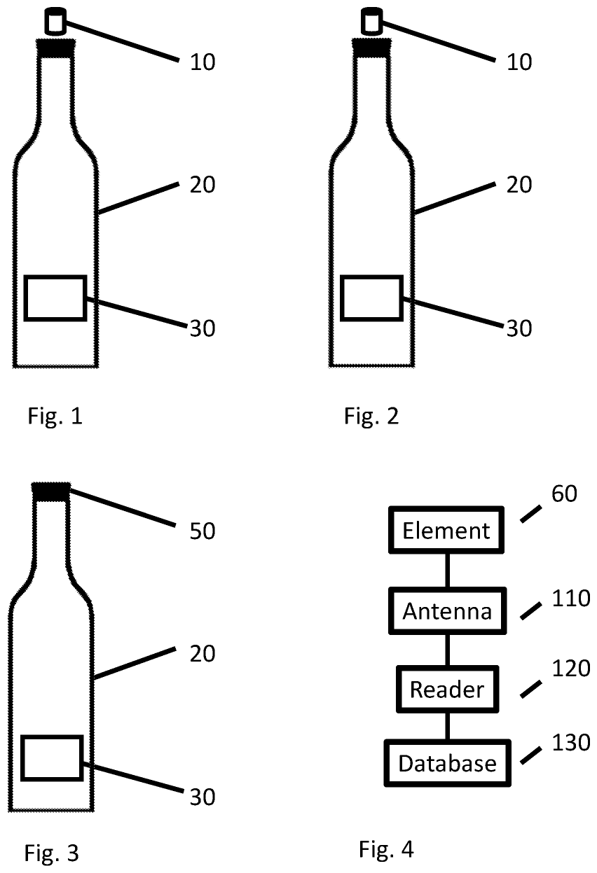

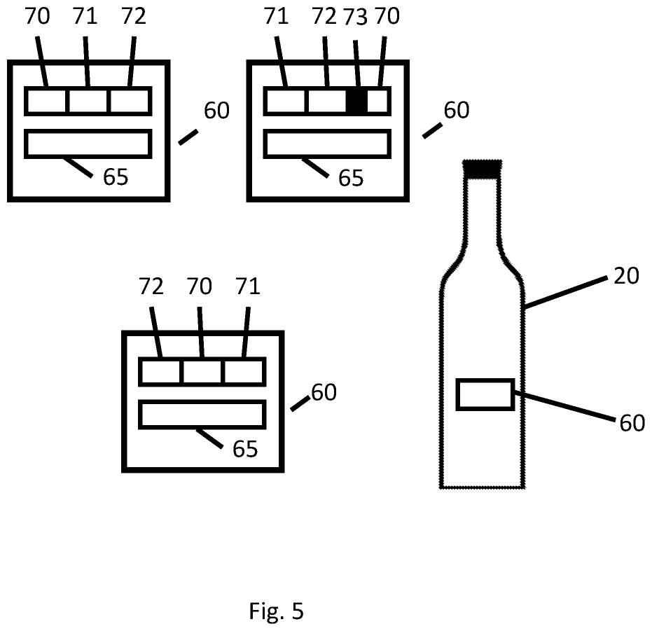

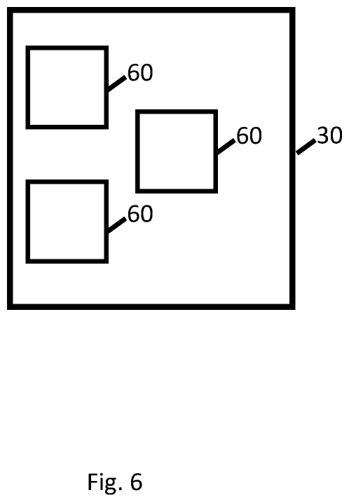

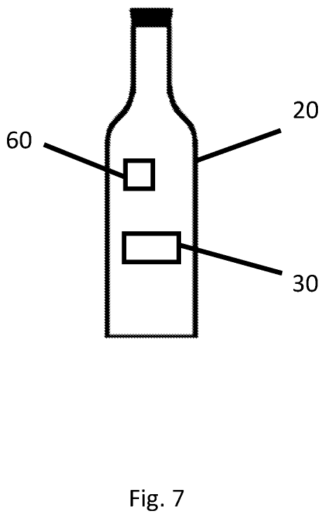

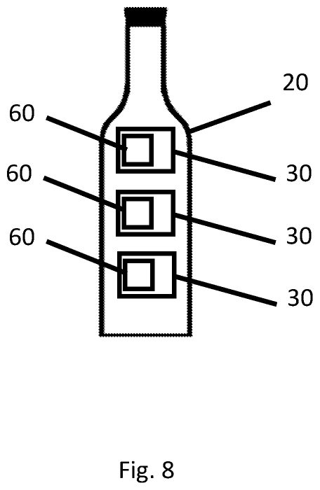

As illustrated in FIGS. 1 and 2, a conventional wine bottle 20 may include various labels 30 which identify the wine, the vineyard, the year, warnings and other information. In accordance with the disclosed technology, one or more of these labels 30 may be or may include one or more identification elements 60 (FIG. 6) and/or one or more identification elements 60 may be separate and apart from labels 30 (FIG. 7) or in lieu of labels 30 (FIG. 5). The one or more identification elements 60 may be arranged relative to one another on a single label 30 (FIG. 6) and/or they may be arranged relative to one another over multiple labels 30 (FIG. 8) such that if someone tries to remove one of the labels 30 or identification elements 60, the location of the identification elements 60 will change and will change relative to at least one of the other identification elements 60 or relative to the bottle 20. In other words, the array of identification elements 60 will be altered. If this happens, the person trying to authenticate the bottle 20 will realize that there is the possibility that the wine inside the bottle 20 is not what is written on the label. In one or more embodiments, the code may change. Additionally, if someone attempts to replace a label 30 and/or identification element 60 or pass off a bottle 20 with one or more fake labels, the bottle will fail to register with the identification element interrogator/reader 120 (FIG. 4).

FIG. 3 illustrates that the cork 10, illustrated in FIGS. 1 and 2, is often covered by a foil 50. According to the disclosed technology, this foil 50 may also be or include one or more identification elements 60. Since this foil 50 must be destroyed, removed or punctured to open the bottle or otherwise access the wine, the identification element 60 may be destroyed, removed and/or damaged which will indicate that the bottle 20 has been opened or otherwise tampered with and thus may no longer be authentic

In one or more embodiments, there may be one or more identification elements 60 located within the cork 10. However, care must be taken not to destroy the integrity of the cork 10 or it may affect the value of the wine.

The identification elements 60 may all be active or passive or there may be a combination of active and passive elements employed. Active identification elements 60 may employ batteries and may include visual and/or audio indicators such as an LED and/or a speaker to allow a person viewing the bottle 20 to determine if the battery is low or not working. Such an indication may be a sign to the person that the bottle may need to be further investigated.

In one or more embodiments, the identification elements 60 may employ Ultra-Wideband (“UWB”) technology. Typically, this technology allows more accurate location determination. However, it may not be required if the identification element reader/interrogator 120 is brought within a small distance of the bottle. 60.

In one or more embodiments, 2 or more identification elements 60 may be attached to the bottle 20. The location on the bottle 20 of each element 60 may be stored in a database 130 (FIG. 4) associated with an identification element reader 120, and/or the location of the identification element 60 relative to another of the identification elements 60. The relative location between an element 60 and any number of the other elements 60 may be stored. For example, the relative location between as few as 2 elements 60 may be stored or the relative location between as many as all the elements 60 may be stored. The more relative locations between element pairs that are stored, the more difficult it will be to remove an element 60 without disturbing one or more of the stored relative locations. Additional information that may be stored includes the type of element 60 (e.g. active, passive, UWB, etc.), information about the bottle 20 (e.g. composition), identification of all security measures applied to the bottle (e.g. location of identifying marks, arrangement of identifying marks, hidden marks, etc.), the storage location of the bottle 20, the name of the last owner etc. If the bottle 20 is stored in a safe location and the location of the bottle 20 is changed, further investigation may be needed to authenticate the bottle.

As illustrated in FIG. 5, one or more identification elements 60 may include information that relates to another identification element 60 and/or to the collectable 20. In this non-limiting example, the collectable is a wine bottle 20 and the wine bottle 20 may include a code 70-72 associated with the bottle 20. Code 70-72 may be numeric, text, alphanumeric, an image, a barcode, QR-code a combination of 2 or more of these or any other manner of identifying the bottle 20. Code 70-72 may be stored in association with one or more of the identification elements 60 in its exact format and/or in a jumbled format. The jumbled format may require a cipher to decode or it may simply be rearranged in a predetermined manner. Additionally, different identification elements 60 may jumble the code 70-72 in different ways. For example, the code 70-72 on the bottle may be 123456789. One or more of the identification elements 60 may include the code 123456789 70-72 and/or the code 456789123 71, 72,70 while another of the identification elements 60 may include the code 789456123 72-70. This is not the only manner of rearranging the code, however, it is presented for ease of explanation. In addition to or instead of the above, one or more embodiments may store a code 70-72 that is a combination of a code associated with the collectable and a code associated with one or more of the identification elements. Thus, in the non-limiting example provided above, the wine bottle 20 may include a code 123456789 associated therewith. One or more identification elements 60 may include a code XYX and one or more identification elements 60 may include a code ABC associated therewith. The identification elements 60 may store one or more codes that combine(s) their code with all of some of the wine bottle code and/or all or some of the code from one or more other identification elements 60. Thus, in the above example, the identification element 60 associated with the XYZ code may look like one or more of the following codes: XYZ123456789ABC, ABC123456789XYZ, XYZ12345ABC6789, X1A2Y3B4Z5C6789, X1A, XYZ123XYZ123XYZ123, or any other full or partial combination of codes. In addition, the code may include one or more portions that do not relate to wine bottle code, or the identification element codes. As illustrated, the code does not need to be the same length as the original codes and any portion of a code may be repeated.

In one or more embodiments, the code 70-72 may include certain characters or groups of characters which are standardized (e.g. a government code, a region code, etc.). In one or more embodiments, that character or group of characters may be required to always be in the same location within the code. In one or more embodiments, there may be at least one check digit 73 within the code 70-72.

The present technology enables the storage and trading or selling of collectables without having to inspect the actual collectable to know that it is authentic. A party may store various collectables in a safe location. When a party wants to trade or sell a collectable, the receiving party need only have the collectable scanned and if the information scans correctly the collectable is authentic, and the receiver may take ownership of the collectable. Ownership may be as simple as changing the name of the owner, without changing the location of the collectable or it may entail changing the name and location or the new owner may take physical possession.

Having thus described one or more embodiments of the technology, advantages can be appreciated. Variations from the described embodiments exist without departing from a scope of the invention. It is seen that systems and methods are provided for protecting the authenticity of a collectable using identification elements such as RFID tags and or smart tags with RFID. Although embodiments have been disclosed herein in detail, this has been done for purposes of illustration only, and is not intended to be limiting with respect to the scope of the claims, which follow. It is contemplated by the inventors that various substitutions, alterations, and modifications may be made without departing from the spirit and scope of the technology as defined by the claims. Other aspects, advantages, and modifications are considered to be within the scope of the following claims. The claims presented are representative of the technology disclosed herein. Other, unclaimed technology is also contemplated. The inventors reserve the right to pursue such technology in later claims.

It is accordingly intended that all matter contained in the above description or shown in the accompanying drawings be interpreted as illustrative rather than in a limiting sense. It is also to be understood that the following claims are intended to cover all of the generic and specific features of the technology as described herein, and all statements of the scope of the technology which, as a matter of language, might be said to fall there between.

Having described the technology, what is claimed as new and secured by Letters Patent is:

1. A system for authenticating a collectable, the system comprising:
a plurality of identification elements connected to the collectable;
wherein at least two of the plurality of identification elements have a location relative to one another; wherein the relative location is associated with at least one of the at least two of the plurality of identification elements; and,
a storage device associated with the plurality of identification elements; wherein the relative location between the at least two of the plurality of identification elements is stored in the storage device.

2. The system according to claim 1 further comprising an interrogation unit which interacts with the at least one of the identification elements to access the relative location.

3. The system according to claim 1 wherein the collectable is a wine bottle.

4. The system according to claim 3 wherein the wine bottle includes a cork and the at least one of the identification elements is connected to the cork.

5. The system according to claim 4 wherein the wine bottle further includes a foil that covers the cork and the at least one of the identification elements is connected to the foil.

6. The system according to claim 1 further including a code associated with the collectable, another code associated with at least one of the identification elements, wherein at least a portion of the code and the another code are combined and stored in the storage device.

7. A method for authenticating a collectable, the method comprising:
connecting a plurality of identification elements to the collectable;
determining a relative location of at least one of the plurality of identification elements with respect to another of the plurality of identification elements;
associating the relative location at least one of the plurality of identification elements; and,
storing the relative location and the association in a storage.

8. The method according to claim 7 wherein the collectable is a wine bottle, the method further including interrogating the at least one of the plurality of identification elements and the another of the plurality of identification elements and comparing a relative location between them with the stored relative location.

9. The method according to claim 7 further including associating a code with one of the plurality of identification elements and another code with the another of the plurality of identification elements.

10. The method according to claim 9 further including combining at least a portion of the code and at least a portion of the another code to form a combined code and associating the combined code with the one of the plurality of identification elements.

11. The method according to claim 9 wherein the code and the another code are identical.

12. The method according to claim 11 further including encrypting the code and associating the encrypted code with at least one of the plurality of identification elements.

13. The method according to claim 12 further including encrypting the code with a different encryption and associating the differently encrypted code with at least the another of the plurality of identification elements.

14. The method according to claim 9 further including associating a collectable code with the collectable and combining at least a portion of the code and at least a portion of the collectable code and associating the combined code with the at least one identification element.

15. The method according to claim 14 further including storing the combined code and its association with the at least one identification element in a storage remote from the collectable.

16. A method for authenticating a collectable, the method comprising:
connecting a plurality of identification elements in an array to the collectable;
storing a configuration of the array in a storage that is remote from the collectable and;
interrogating at least one of the plurality of identification elements to determine the array configuration; and,
comparing the stored configuration to the determined configuration.

17. The method according to claim 16 wherein when the comparison results in a match the collectable is authentic.

18. The method according to claim 16 wherein when the comparison results in a mismatch the collectable may not be authentic.

19. The method according to claim 16 further comprising associating at least one code with at least one of the plurality of identification elements and storing the at least one code and the association with the at least one of the plurality of identification elements in the remote storage.

20. The method according to claim 19 further including associating another code with at least another of the plurality of identification elements;
combining at least a portion of the code and at least a portion of the another code to form a combined code and associating the combined code with the at least one of the plurality of identification elements; and,
storing the combined code and its association with the at least one of the plurality of identification element in the remote storage.
